(19) United States
(12) Patent Application Publication
(10) Pub. No.: US 2024/0403664 A1
(43) Pub. Date: Dec. 5, 2024

(54) DETERMINING MISSING RELATIONSHIP INFORMATION AND AUGMENTING A KNOWLEDGE GRAPH

(71) Applicant: International Business Machines Corporation, Armonk, NY (US)

(72) Inventors: Lei GAO, XIAN (CN); Xiang Zhen GAN, Xian (CN); Ke DU, Xian (CN); Jin WANG, Xian (CN); A Peng ZHANG, Xian (CN); Xian WU, Xian (CN)

(21) Appl. No.: 18/328,977

(22) Filed: Jun. 5, 2023

(51) Int. Cl. G06N 5/022

(52) U.S. Cl. CPC G06N 5/022

(57) ABSTRACT

Determining missing relationship information and augmenting a knowledge graph includes obtaining a knowledge graph with nodes representing entities and edges representing relationships between related entities, building a dataset indicating attribute(s) and attribute value(s) of each entity of a related entity pair, a relationship type of the relationship between the related entity pair, and a weight of the relationship type, using the dataset to build machine learning model(s), receiving a partial specification of a new relationship triple, the specification including the new source entity and missing relationship information of the new relationship triple, applying one or more of the model(s) and identifying the missing relationship information, and augmenting the graph to provide an augmented knowledge graph that includes the new relationship triple, including the new source entity, the target entity, and the relationship type of the relationship between the new source entity and the target entity.

### BACKGROUND

A knowledge graph represents a network of real-world entities and the relationships between them. This information is usually stored in a graph database and visualized as a graph structure. It is sometimes known as a ‘semantic network’. The graph is typically made up of nodes (representing entities), edges between the nodes (representing relationships between the entities represented by the nodes), and labels. A knowledge graph facilitates question answering and search systems, for instance in the retrieval of answers to given queries. Often when building/adding to a knowledge graph, information is added by a triplet of information (a ‘relationship triple’), which indicates two node entities and an edge between them to identify relationship(s). Sometimes one or both entities already exist in the knowledge graph and therefore it may not be necessary to add node(s) to the graph.

### SUMMARY

Shortcomings of the prior art are overcome and additional advantages are provided through the provision of a computer-implemented method. The method includes obtaining an initial knowledge graph that includes nodes representing entities and edges representing relationships between related entities of the entities. The method also includes building a dataset based on the initial knowledge graph. The dataset indicates, for each related entity pair, of a collection of related entity pairs, between which a relationship exists as represented in the initial knowledge graph: at least one attribute and at least one attribute value of a first entity of the related entity pair, at least one attribute and at least one attribute value of a second entity of the related entity pair, a relationship type of the relationship between the related entity pair, and a weight of the relationship type. The method also includes using the dataset to build a collection of machine learning models for identifying missing relationship information. The collection of machine learning models includes at least one clustering model and at least one classification model. The method further includes receiving a partial specification of a new relationship triple to include in the initial knowledge graph. The new relationship triple includes a new source entity, a target entity, and a relationship type of a relationship between the new source entity and the target entity. The partial specification of the new relationship triple includes a specification of the new source entity and is missing at least some relationship information of the new relationship triple. The method additionally includes applying one or more machine learning models of the collection of machine learning models and identifying the missing at least some relationship information of the new relationship triple to provide a complete specification of the new relationship triple. Further, the method includes augmenting the initial knowledge graph using the complete specification of the new relationship triple. The augmenting provides an augmented knowledge graph that includes the new relationship triple, including the new source entity, the target entity, and the relationship type of the relationship between the new source entity and the target entity.

Additional aspects of the present disclosure are directed to systems and computer program products configured to perform the methods described above and herein. The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example knowledge graph;

FIG. 3 depicts another example knowledge graph but with missing relationship information;

FIG. 4 depicts an example knowledge graph that includes the missing relationship information;

FIG. 5 depicts an example dataset based on an initial knowledge graph, in accordance with aspects described herein;

FIG. 6 depicts further details of an example knowledge graph module to incorporate and/or use aspects described herein; and

FIG. 7 depicts an example process for determining missing relationship information and augmenting a knowledge graph, in accordance with aspects described herein.

### DETAILED DESCRIPTION

Described herein are approaches for intelligent completion of missing relationship information for a knowledge graph. As an example, aspects can be applied when entity and/or relationship information is added to a graph database but results in at least some incomplete or missing information relative to one or more entities and/or relationship(s) between them.

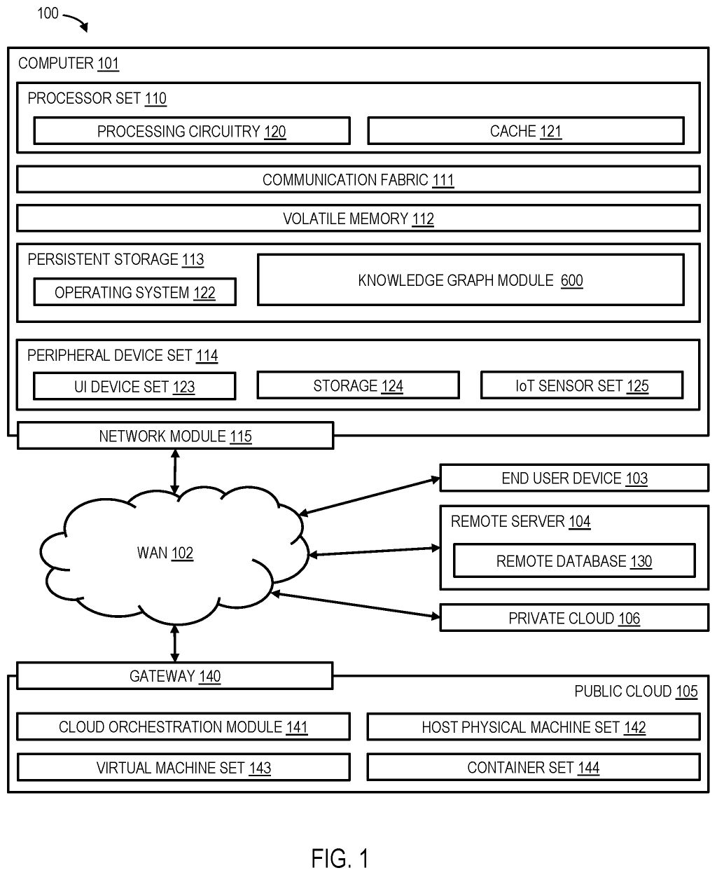

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing aspects of the present disclosure, such as code of knowledge graph module 600. In addition to block 600, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 600, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 121 and the other storage media discussed below. The program instructions, and associated data, are accessed by processor set 110 to control and direct performance of the disclosed methods. In computing environment 100, at least some of the instructions for performing the disclosed methods may be stored in block 600 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 600 typically includes at least some of the computer code involved in performing the disclosed methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the disclosed methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

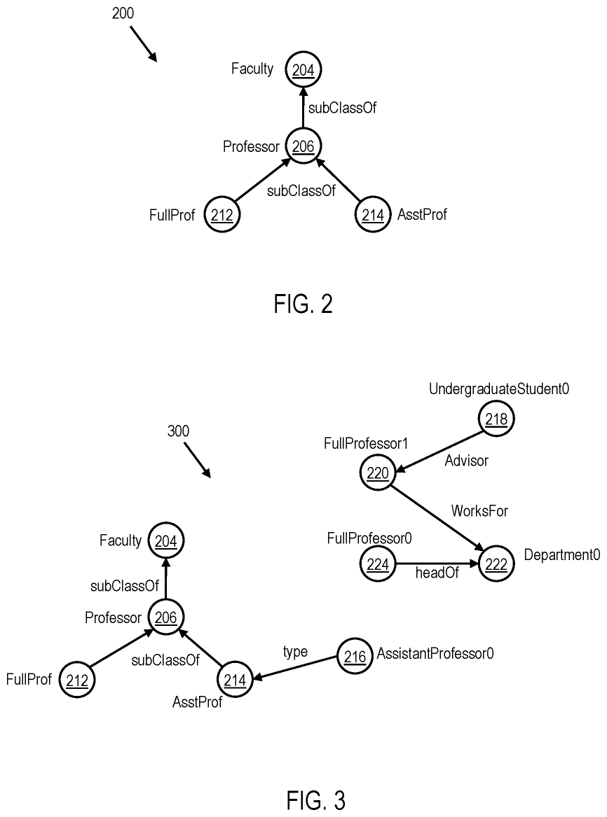

FIG. 2 depicts an example knowledge graph 200. In knowledge graphs depicted and described herein, arrows extending between nodes represent relationships of varying types, and the terms ‘entity’ and ‘node’ (including their plurals) may be used interchangeably herein since a node is representative of a given entity.

Graph 200 in this example represents various entities of a university. The university has Faculty, which is a class entity represented by node 204. Faculty could itself be a sub-class of another class of university entities. A subclass of Faculty is the Professor entity represented by node 206. There may be various subclasses of the Professor class. Here, the subclasses are Full Professor and Assistant Professor entities represented by nodes 212, and 214, respectively.

It might be desired to expand/augment the knowledge graph by adding information such as additional entities and/or relationships, for instance to specify specific faculty (people) and how they relate to the existing entities in the knowledge graph. The added information may be provided by a user, as an example, using an interface. Sometimes the provider of added information might miss or otherwise omit identifying a node entity (such as a target entity of a relationship with a source entity) and/or relationship that exists between a source entity and target entity. When adding a new relationship triple into a knowledge graph, the user typically adds an entity name for a new source entity, specifies a target entity as either a new entity to add or by selecting an entity already in the knowledge graph, and indicates a relationship definition/type to use for a relationship between the indicated source and target. Sometimes, however, the user lacks sufficient information to fill in the relationship and/or identify the target node entity.

In situations of missing relationship information of a new relationship triple (source, target, relationship type), the graph may not be completed to properly relate the source and target entities. As a result, a query made against the graph would potentially lead to an inaccurate/incomplete response on account of the missing information.

In accordance with aspects described herein, facilities are provided to intelligently complete information when a relationship triple is to be added to a knowledge graph, such as in situations like that described above. In examples, a user provides, and a system receives, a partial specification of a new relationship triple to include in an initial knowledge graph, where the new relationship triple includes a new source entity, a target entity, and a relationship type of a relationship between the new source entity and the target entity, but the partial specification is missing at least some relationship information of the new relationship triple, for instance an indication of the target entity and/or relationship type to use between the source and the intended target.

FIG. 3 depicts another example knowledge graph 300 but that is missing relationship information. The example builds from the example of graph 200 of FIG. 2. and presents a situation that might result after a user provides only partial specifications of relationship triples. Specifically, the user has specified entities 216, 218, 220, 222 and 224. The user has also provided some relationship information between various of these entities. The relationship information is illustrated by arrows that extend from a source entity of the relationship to a target entity of the relationship. For instance, entity AssistantProfessor0 represented by node 216 has been related to the Assistant Professor entity 214, since AssistantProfessor0, an actual person for instance, who works for the university as an assistant professor. AssistantProfessor0 is a type of Assistant Professor, as indicated. Meanwhile, some relations have been specified between nodes 218, 220, 222, and 224. The relationship between the UndergraduateStudent0 entity (node 218) and the FullProfessor1 entity (node 220) is that FullProfessor1 is the advisor of UndergraduateStudent0. Additionally, the relationship between FullProfessorl and the Department entity (node 222) is that FullProfessor1 works for Department0, one of the university departments, and the relationship between the FullProfessor0 entity (node 224) and Department0 is that FullProfessor0 is the head of Department0.

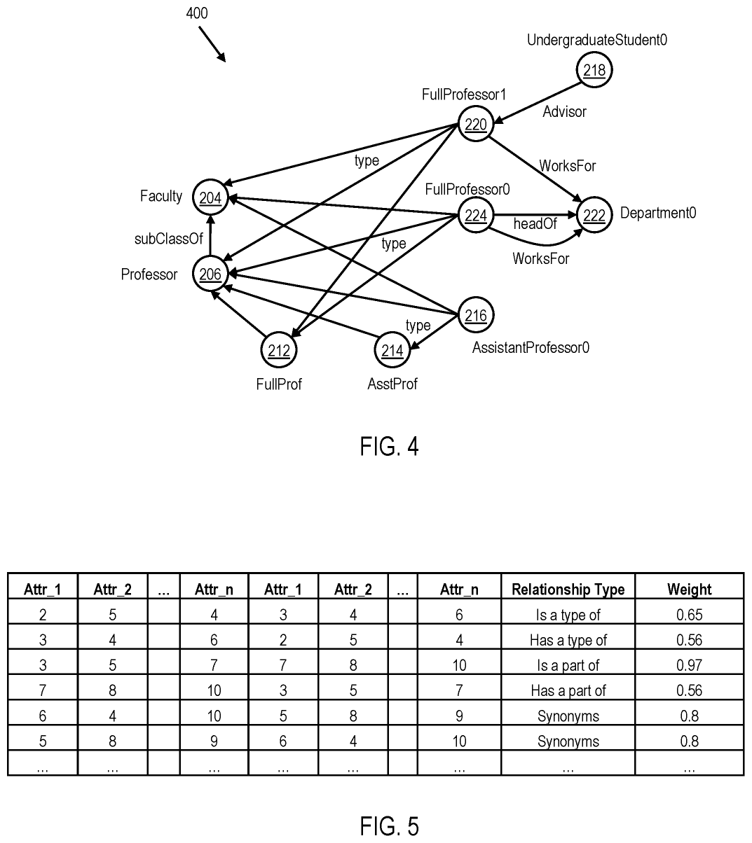

There is still a significant amount of implicit relationship information missing from the example of FIG. 3, and in this example the graphs are even disjoint (no relation between them). FIG. 4 depicts an example knowledge graph 400 that includes the missing relationship information. Various relationship information is reflected by arrows that properly reflect relationship triples. For any given pair of related entities (a “related entity pair”), at least one relationship exists as represented by a labeled arrow extending from a source entity node of the related entity pair to a target entity node of the related entity pair.

The knowledge graph 400 of FIG. 4 in comparison to the knowledge graph 300 of FIG. 3 enables a more complete analysis, understanding, and identification of the relations between entities, which is advantageous in various applications, such as querying applications where a query is made against the knowledge graph. By way of specific example, if it is desired to query all of the university Faculty, querying the incomplete graph 300 of FIG. 3 returns only AssistantProfessor0, while querying the more complete knowledge graph 400 of FIG. 4 returns FullProfessor1 and FullProfessor0, in addition to AssistantProfessor0.

In accordance with aspects presented herein, a process obtains an existing knowledge graph, termed herein an ‘initial knowledge graph’. The initial knowledge graph includes nodes that represent entities and edges that represent relationships between related entities. The process ingests the attributes of each related entity pair and constructs a dataset (for instance a data structure/table) with edge (relationship) information for the related entity pair. A related entity pair is a pair (source and target) for which relationship information has already been defined in what is provided in/with the initial knowledge graph. The process also defines and determines a weight for the relationship of each entity pair and includes such weight in the dataset. Based on the dataset, the process builds a suite of machine learning models, for instance clustering and classification models. In examples, an overall clustering model, a respective clustering model for each relationship type identified from the initial knowledge graph, and an overall classification model are built as described herein. Based on the model suite, the process can predict missing relationship information in different scenarios where a user (or other entity) provides partial specifications of relationship triples. For instance, a process applies the models to determine missing relationship information and complete otherwise incomplete relationship triples. The initial knowledge graph can then be augmented with the completed relationship triples. In some embodiments, this can be performed as a user enters a new source entity for inclusion in the initial knowledge graph. In some embodiments, based on a user specifying a new source entity to add to the initial knowledge graph, a process could predict in real-time, as the user provides the source entity information/attributes, a target entity and/or relationship type to use with that new source entity, automatically suggesting it to the user for selection.

As noted, one aspect is construction of a dataset, for instance one or more data structures, based on the existing initial knowledge graph. The dataset can indicate various information for each related entity pair (of a collection of related entity pairs) between which a relationship exists as represented in the initial knowledge graph. Such information can include, for example, at least one attribute and at least one attribute value of a first entity of the related entity pair, at least one attribute and at least one attribute value of a second entity of the related entity pair, a relationship type of the relationship between the related entity pair, and a weight of the relationship type.

One aspect of building the dataset is defining the records for the dataset. In a specific example the dataset includes rows and columns, and each row represents a relationship for a related entity pair of the collection of related entity pairs. It is noted that, for a pair of entities (entity A, entity B) with a relationship therebetween, this relationship can be presented as one record or can be expanded as two records. In this regard, relationships might be directed, with (i) a relationship, in one direction, of entity A to entity B being a first relationship type (say, professor A is the advisor of student B) and (ii) a relationship, in another direction, of entity B to entity A being a second relationship type (say, student B is the advisee of professor A). In this situation, building the dataset can include indicating in the dataset both the first relationship type and a weight thereof as one record/row, and the second relationship type and a weight thereof as another record/row.

Columns of the dataset can include columns of attributes. Entities have attributes associated with them. Attributes usually have two aspects to them—the attribute name/type, and an attribute value for a given entity. An example attribute in the context of FIGS. 2, 3 and 4 might be a job title attribute. Example attribute values for that attribute might be ‘Department Head’ and ‘Professor’ (or even more specifically ‘Visiting Professor’, ‘Associate Professor’, ‘Full Professor’ and ‘Assistant Professor’). It is noted that different entities might not share the same set of attributes. An undergraduate student, for example, might not have a job title attribute like a Professor would but might have (as one example) a ‘StudentType’ attribute to distinguish between full time students and part time students.

If all of the entities in the initial knowledge graph have the same set of attributes (they match), then these attributes themselves can be columns of the dataset. If instead the attributes of the entities are not the same (they differ across the entities), then the attributes of the entities can be aligned by pre-defined categories to relate attributes that differ but are related, and these categories can be used as columns in the dataset. For instance, assume the following:
original attributes of the FullProfessor entity type are: place of birth, major, date hired, date graduated, number of publications, and number of current research projects; and
original attributes of the UndergraduateStudent entity type are: place of birth, major, admission date, and grade point average.

Because of the differences in attributes between the FullProfessor entity and the UndergraduateStudent entity, categories can be defined to align their attributes. For purposes of the dataset building, a refined set of attributes of the FullProfessor entity can become {place of birth, major, experience (which includes the date hired and date graduated attributes), achievement (which includes the number of publications and number of current research projects attributes)}, while a refined set of attributes of the UndergraduateStudent entity can become {place of birth, major, experience (which includes the admission time attribute), achievement (which includes the grade point average attribute)}. The two entities will therefore have the same (refined) attributes based on this categorization: age, major, experience, and achievement, which can be used as a respective four attribute columns for each entity in the dataset, as illustrated and described below with reference to FIG. 5.

The dataset can also provide relationship information about the relation between the source entity and the target entity, for instance an indication of the type(s) of relationship(s) between the related entity pair and weight(s) of the relationship type(s).

In determining a weight value of a relationship type, assumptions could be made. One such assumption is an importance of the relationship. The importance can be predefined/input and be based on any desired factors. Table 1 below provides an example relationship-importance correlation table:

TABLE 1
Relationship-Importance Correlation

| Relationship | Importance | Value |
|---|---|---|
| Synonyms | High | 0.9 |
| Is a part of | Medium | 0.8 |
| Is a type of | Low | 0.7 |

By the above, a Synonyms relationship (for instance ‘entity A is a synonym of entity B’) is indicated as being high importance. An ‘is a part of’ relationship (for instance ‘entity A is a part of entity B’) is indicated as being medium importance, while an ‘is a type of’ relationship (for instance ‘entity A is a type of entity B’) is indicated as being low importance. Table 1 also includes weights for each relationship, the weights representing a relationship strength factor. A high-importance relationship here is weighted higher than both medium and low importance relationships.

Another assumption is made with respect to a search distance between the related entities. Search distance refers to the shortest pathlength, in the knowledge graph, between the first entity and the second entity. For any given relationship type, a relationship of entities with a shorter search distance to each other is to be stronger than a relationship of entities with a longer search distance to each other. For example, if the search distance from entity A to entity B in the graph is less than the search distance of entity A to entity C (even if the same relationship type exists from A to B as it does from A to C), a larger weight value is to be given to the relationship from entity A to entity B.

Based on the above, the weight of the relationship type, as indicated in the dataset for a pair of related entity nodes, may be a function of two factors: Weight₁* Weight₂, where Weight₁ is the relationship strength factor that is predefined for the relationship type (for instance 0.9 for the Synonyms relationship as indicated above) and Weight₂ is a path length factor of the related entity pair. The path length factor (Weight₂) may be a function of more than one pathlength. In a specific example, the path length factor, Weight₂, is given by:

$$\\ {Weight}_{{}_{} 2} = 1 - \frac{( PathLength - 1 )}{Max PathLength}$$

where the PathLength is the length of the search path between the two entities, i.e., the shortest pathlength, in the initial knowledge graph, between the first entity and the second entity, and MaxPathLength is the maximum path search length among all the relationships of the initial knowledge graph, i.e., a longest PathLength of a set of PathLengths of the initial knowledge graph, the set of PathLengths consisting of, for each pair of entities of the plurality of entities, the shortest pathlength between that pair of entities. In other words, the MaxPathLength is the length of the longest search distance (PathLength) across all of the related node pairs of the initial knowledge graph.

FIG. 5 depicts an example dataset based on an initial knowledge graph, in accordance with aspects described herein. The dataset is provided in row-column format in this example. The first row contains column headings. In this example, source and target entities have the same n number of attributes, Attr_1, Attr_2, . . . , Attr_n. The first four columns are for the source entity's attributes Attr_1, Attr_2, . . . , Attr_n. The next four columns (columns 5 through 8) are for the target entity's attributes Attr_1, Attr_2, Attr_n. The 9^{th} column indicates the relationship type of the relationship from the source entity to the target entity, and the 10^{th} column indicates the weight of that relationship (for instance based on the equation above). Each row (except the first row) corresponds to a specific relationship between two specific entities, i.e., from a source entity to a target entity. Since relationships are directed, then a row pair (for instance rows 2 and 3 of FIG. 5) corresponds to the relationships between a first entity (A) and a second entity (B), with (i) row 2 corresponding to the relationship in a first direction from entity A, as the source entity of that relationship, to entity B, as the target entity of that relationship, and with (ii) row 3 corresponding to the relationship in a second direction from entity B, as the source entity of that relationship, to entity A, as the target entity of that relationship. Due to this, it is seen that the attribute values (3, 4, . . . , 6) of the target entity in row 2 match the attribute values (3, 4, . . . , 6) of the source entity in row 3(because they are the same entity) and the attribute values (2, 5, . . . , 4) of the source entity in row 2 match the attribute values (2, 5, . . . , 4) of the target entity in row 3 (because they are the same entity). Additionally, it is seen that the ‘is a type of’ relationship type and the ‘has a type of’ relationship type are complimentary relationship types, and thus entity A ‘being a type of’ entity B means that entity B ‘has a type of’ entity A. The next row pair (rows 4 and 5) provide the relationship information for a different related entity pair.

Aspects described herein also use the dataset to build a collection of machine learning models for identifying missing relationship information. The collection of machine learning models can include at least one clustering model and at least one classification model.

For example, the collection of machine learning models can include an overall clustering model that indicates, for an input source entity, such as a new source entity specified by a user, an existing source entity of the initial knowledge graph that is most closely related/similar (e.g., based on attributes and values thereof) to the new source entity. The indicates existing source entity is that is a source entity of one or more existing relationships in the graph. Clustering models provide a way of categorizing the entities into a number of clusters, which helps to identify groups of similar data and to label the data according to the group to which it/they belong. In the context of entities of the knowledge graph, the model can take attribute data of an entity, as input, and determine the entity/entities in the knowledge graph that are closest, from a relationship standpoint, to the input entity.

The collection of machine learning models can also include clustering model(s) for specific relationship type(s). More specifically, at least one relationship-specific clustering model can be built, where the at least one relationship-specific clustering model includes, for each relationship type indicated by the dataset, a respective relationship-specific clustering model that clusters entities based on that relationship type. In accordance with this aspect, a process can select out the cases of a specific kind of relationship and build a clustering model for that relationship type. Each relationship type reflected can therefore have a corresponding clustering model. The model can cluster entities based on the strength of the relationship (of the given type) as between pairs of entities.

The collection of machine learning models can also include an overall classification model that predicts a relationship type of a relationship between an input source entity and an input target entity based on attributes of those input entities. The predictors—the features on which a prediction as to the target (relationship) will be made—can be the attribute columns of the dataset and the —what is predicted given the set of attribute columns (predictors) involved—can be the relationship type.

In some aspects, before building the models a process can select which attributes to use in building the overall clustering model and the at least one relationship-specific clustering model. This can help increase the accuracy of the clustering models, for instance. This selection of the important attributes can include building a regression model that uses the weights of the different relationship types (i.e., in the weight column of the dataset) as targets and the attributes (the attribute columns) as the predictors. With the regression model, the process can determine the prediction intervals (prediction interval values) for the regression model and use these to inform a ranking of the attributes in terms of their prediction interval, which can be taken as a measure of importance. The process can then select, as the important attributes to use, those attributes for which the corresponding prediction interval is above a selected/specified threshold. In some embodiments, from the selected important attributes, the process selects those that are common/shared as between the source and target entities (i.e., columns that are presented for both entities.). Based on those attributes that are selected, they are used as the appropriate attributes from the source and target entities indicated in the dataset in building the clustering models.

In specific examples, a first important feature (attribute) set is selected from the source entity columns, a second important feature (attribute) set is selected from the target entity columns, and then the final selected attribute set is the logical union of those two sets.

At some point, a user (or other entity) provides, and the process receives, a partial specification of a new relationship triple to include in the initial knowledge graph. As discussed above, a relationship triple includes indications of at least a source entity, a target entity, and a relationship type of a relationship between the source entity and the target entity. In examples, the partial specification of the new relationship triple includes (at least) a specification of a new source entity for the relationship to be added to the initial knowledge graph, but is missing at least some relationship information of the new relationship triple. For example, the user might have specified the new source entity, including attributes thereof, but might have failed to specify both the target entity for a relationship that the new source entity has and the type of that relationship. Alternatively, the user might have specified the new source entity and indicated the target entity, which could be an existing entity in the initial knowledge graph (for which its attributes are known) or could be a new target entity that the user specifies, including the attributes of that new target entity, but did not specify the relationship type between them. As yet another possibility, the user might have specified the new source entity and a relationship type of a relationship that that new source entity has, but did not specify the target entity of that relationship. In any of these situations, the user has provided only a partial specification of the new relationship triple, where at least some relationship information (indication of target entity and/or relationship type) of that new relationship triple is missing.

In accordance with aspects described herein, with the models built as described above a process can apply them and identify, for each of one or more partially specified relationship triples, the missing relationship information of those. For instance, for a partial specification of a relationship triple, the process can check for and determine the missing elements in order to form a completed relationship triple to properly augment the initial knowledge graph.

As noted, there are three scenarios of missing elements/relationship information when adding a new relationship triple to the initial knowledge graph:
Scenario 1: User specified two entities—a new source entity and a target entity, either already existing in the graph or a new one that the user also specifies, including the attributes thereof—but a relationship type as between the two is missing: In this situation, the partial specification of the new relationship triple includes the new source entity and also an indication of the target entity, the missing relationship information includes the relationship type of the relationship between the new source entity and the target entity. A process therefore applies the classification model to predict the relationship type of the relationship between the new source entity and the target entity. The predicted relationship type completes the relationship triple, and the initial knowledge graph is then augmented using the completed relationship triple to add the new source entity and relate the added new source entity in the initial knowledge graph to the target entity—either already present or also newly added to the graph—with the predicted relationship type.
Scenario 2: User specified a new source entity and a relationship type for that entity but the target entity of that relationship is missing. In this situation, the partial specification of the new relationship triple includes the new source entity and the relationship type of the relationship between the new source entity and the (unknown) target entity, the missing relationship information includes an indication of the target entity, the allocation of the machine learning model(s) and identifying the missing relationship information includes applying the relationship-specific clustering model for the relationship type, and identifying, based on the applying the relationship-specific clustering model, a nearest entity in the initial knowledge graph. Augmenting the initial knowledge graph in this situation includes adding the new source entity to the initial knowledge graph and relating the added new source entity in the initial knowledge graph to the identified nearest entity, as the target entity, with the relationship type.
Scenario 3: User specified a new source entity but a relationship type and target entity of that relationship is missing. In this situation, the missing relationship information includes an indication of the target entity and the relationship type of the relationship between the new source entity and the target entity. The use of the machine learning model(s) and identification of the missing relationship information in this situation uses the overall clustering model to determine a similar source entity in the initial knowledge graph that is most closely related to the new source entity, and then uses relationship-specific clustering model(s) to find the most closely related entity to that similar source entity (i.e., the one to which the similar source entity has the strongest relationship). The most closely related entity may be used as the target entity for the new relationship to be added, and the relationship type to use may be the type of relationship that is identified as being strongest.

To help illustrate Scenario 3, consider the following. The overall clustering model can be used to take as input an indication of the new entity (A) and provide an indication of the identity of the most similar source entity (B) already existing in the graph. Since B is a source entity, it has one or more existing relationships reflected in the graph, and those relationships are with one or more entities (Cᵢ). In Scenario 3, the user specifies the new source entity A to serve as a source entity in a relationship that the user wants to add but fails to specify the relationship and the target. Accordingly, the overall clustering model can be used to identify B, in the existing graph, that is most similar to A. B has existing relationship(s) Rᵢ for which B is the source entity. Each Rᵢ (relationship) of the set of these existing relationship(s) has a corresponding Cᵢ entity—the target of the relationship—and a known relationship type. The corresponding relationship-specific clustering model(s) for the relationship type(s) can b used to identify the Cᵢ to which B has the strongest relationship. At that point, the process has an identification of (i) an existing source entity (B) in the graph that is most closely related to the new source entity (A) to add, and (ii) an indication of the strongest relationship that B has to any of the target entities to which B is related. The target of the strongest relationship, and the type of that relationship, form the missing information of Scenario 3.

Accordingly, in Scenario 3, the processes applies the overall clustering model to determine an existing source entity, of the initial knowledge graph, that is most similar to the new source entity, the existing source entity being a source entity of one or more existing relationships reflected in the initial knowledge graph, and applies, for each relationship type of the one or more existing relationships, the respective relationship-specific clustering model of the at least one relationship-specific clustering model. That applying determines a strength of each existing relationship of the one or more existing relationships. The process also identifies, based on the strength of each existing relationship of the one or more existing relationships, a strongest existing relationship of the one or more existing relationships. That strongest existing relationship is between the existing source entity and an existing target entity, and has an identified relationship type. Augmenting the initial knowledge graph in this situation includes adding the new source entity to the initial knowledge graph and relating the added new source entity in the initial knowledge graph to the existing target entity with a relationship of the identified relationship type.

In some embodiments in the prediction process that predicts a relationship type and/or a target entity for the new source entity being specified, the model(s) might identify a list of candidate relationship types and/or target entities as appropriate. In these cases, a predefined probability threshold (or similar kind of threshold) could be used as a cut-off for inclusion on the candidate list or to prune the candidate list to keep the ‘best’ options. The candidates could then be provided/indicated for the user to make a selection of the relationship type/target entity to use for the triple information and ultimately to augment the initial knowledge graph. In a specific embodiment, a user enters details of a new source entity to add to the existing graph as part of a relationship triple, and the process predicts a target entity and/or relationship type for the relationship triple and presents the best candidates to the user in a list. The user can then select from that list if the desired target entity and/or relationship type is provided.

As noted, with a completed relationship triple, the information thereof informs a complete source-target-relationship triplet so use to augment the initial knowledge graph. In this regard, augmenting the initial knowledge graph could include (i) modifying the initial knowledge to include the new relationship triple, or (ii) building a new knowledge graph based on the initial knowledge graph (that includes the elements of the initial knowledge graph) and that includes the new relationship triple.

It is further noted that aspects can be described herein for multiple partially-specified relationship triples. A user might desire to augment a knowledge graph with a collection of new relationships, in which case the user can provide one or more partial specifications of different relationship triples, and processing described herein can iteratively complete the relationship triples and augment the graph accordingly. It is also noted that a dataset may be periodically or aperiodically (re) built as the knowledge graph is augmented/expanded, and the machine learning model(s) can be also similarly be (re) built, which will help ensure that the dataset and models based thereon are updated.

Aspects described herein can automatically and intelligently help a user to complete missing elements when adding new triple information to an existing knowledge graph. Aspects consider different scenarios surrounding missing elements when a user attempts to add new entity and relationship information to a knowledge graph, and assist in properly completing the information and augmenting the knowledge graph to facilitate accurate and efficient use of the graph for query-based or other applications of graph search and traversal.

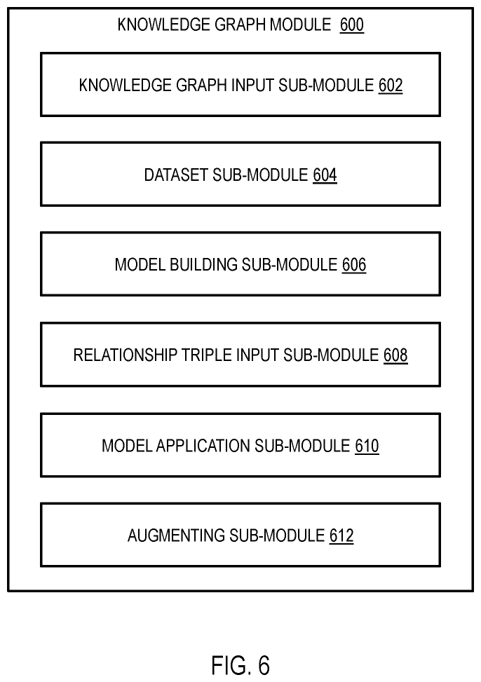

FIG. 6 depicts further details of an example knowledge graph module (e.g., knowledge graph module 600 of FIG. 1) to incorporate and/or use aspects described herein. In one or more aspects, knowledge graph module 600 includes, in one example, various sub-modules to be used to perform determination of missing relationship information and augmenting of a knowledge graph. The sub-modules can be or include, e.g., computer readable program code (e.g., instructions) in computer readable media, e.g., persistent storage (e.g., persistent storage 113, such as a disk) and/or a cache (e.g., cache 121), as examples. The computer readable media may be part of a computer program product and may be executed by and/or using one or more computers or devices, and/or processor(s) or processing circuity thereof, such as computer(s) 101, EUD 103, server 104, or computers of cloud 105/106 of FIG. 1, as examples.

Referring to FIG. 6, the knowledge graph module 600 includes knowledge graph input sub-module 602 for obtaining an initial knowledge graph, dataset sub-module 604 for building a dataset based on the initial knowledge graph, model building sub-module 606 for using the dataset to build a collection of machine learning models for identifying missing relationship information, relationship triple input sub-module 608 for receiving a partial specification of a new relationship triple to include in the initial knowledge graph, model application sub-module 610 for applying one or more machine learning models of the collection of machine learning models and identifying missing at relationship information, and augmenting sub-module 612 for augmenting the initial knowledge graph using a complete specification of the new relationship triple.

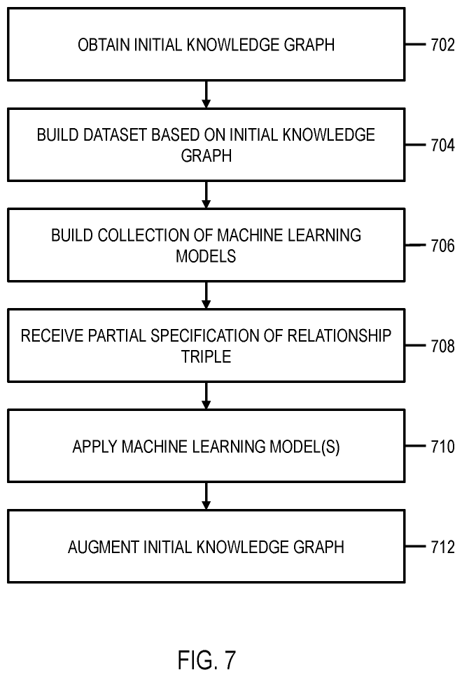

FIG. 7 depicts an example process for determining missing relationship information and augmenting a knowledge graph, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 6 are part of a module, such as module 600. In other examples, the code may be included in one or more modules and/or in one or more sub-modules of the one or more modules. Various options are available.

The process of FIG. 7 includes obtaining (702) an initial knowledge graph. The initial knowledge graph includes nodes representing a plurality of entities and edges representing relationships between related entities of the plurality of entities. The process also includes building (704) a dataset based on the initial knowledge graph. The dataset indicates, for each related entity pair, of a collection of related entity pairs, between which a relationship exists as represented in the initial knowledge graph: at least one attribute and at least one attribute value of a first entity of the related entity pair, at least one attribute and at least one attribute value of a second entity of the related entity pair, a relationship type of the relationship between the related entity pair, and a weight of the relationship type.

In some embodiments, the process includes determining the weight of the relationship type based on factors that include (i) a relationship strength factor that is predefined for the relationship type, and (ii) a path length factor of the related entity pair. The path length factor is a function of a shortest pathlength, in the initial knowledge graph, between the first entity and the second entity, and a longest pathlength of a set of pathlengths of the initial knowledge graph, the set of pathlengths consisting of, for each pair of entities of the plurality of entities, a respective shortest pathlength between that pair of entities.

In embodiments, and for a related entity pair of the collection of related entity pairs, a relationship, in one direction, of the first entity to the second entity is a first relationship of a first relationship type and a relationship, in another direction, of the second entity to the first entity is a second relationship of a second relationship type. In these situations, building the dataset includes indicating in the dataset (i) the first relationship type, (ii) a weight of the first relationship type, (iii) the second relationship type, and (iv) a weight of the second relationship type.

In embodiments, the dataset includes rows and columns, where each row represents a relationship for a related entity pair of the collection of related entity pairs, and where the building the dataset defines the columns as being (i) attributes of the plurality of entities, based on the attributes of the plurality of entities matching across the plurality of entities and/or (ii) defined categories of attributes that differ but are related, based on the attributes of the plurality of entities differing across the plurality of entities.

Continuing with the process of FIG. 7, the process also includes using the dataset to build (706) a collection of machine learning models for identifying missing relationship information. The collection of machine learning models includes at least one clustering model and at least one classification model.

For instance, the collection of machine learning models can include (i) an overall clustering model that indicates, for an input source entity, an existing source entity of the initial knowledge graph that is most similar to the input source entity, (ii) at least one relationship-specific clustering model, the at least one relationship-specific clustering model including, for each relationship type indicated by the dataset, a respective relationship-specific clustering model that clusters the plurality of entities based on that relationship type, and (iii) a classification model that predicts a relationship type of a relationship between an input source entity and an input target entity based on attributes of the input source entity and the input target entity.

In embodiments, building the overall clustering model and the at least one relationship-specific clustering model includes selecting which attributes to use in building the overall clustering model and the at least one relationship-specific clustering model. The selecting can include building a regression model that uses weights of relationship types indicated in the dataset as targets and attributes indicated in the dataset as predictors, then determining prediction intervals value for the regression model, and selecting, as the attributes to use, those attributes for which the corresponding prediction interval is above a selected threshold. Based on the selected attributes to use, the process can use those selected attributes from source entities and target entities indicated in the dataset in building the overall clustering model and the at least one relationship-specific clustering model.

The process of FIG. 7 also includes receiving (708) a partial specification of a new relationship triple to include in the initial knowledge graph. The new relationship triple is to include a new source entity, a target entity, and a relationship type of a relationship between the new source entity and the target entity. The partial specification of the new relationship triple includes a specification of the new source entity and is missing at least some relationship information of the new relationship triple. The process therefore applied (710) one or more machine learning models of the collection of machine learning models and identifies the missing at least some relationship information of the new relationship triple to provide a complete specification of the new relationship triple. The process also augments (712) the initial knowledge graph using the complete specification of the new relationship triple. This augmenting provides an augmented knowledge graph that includes the new relationship triple, including the new source entity, the target entity, and the relationship type of the relationship between the new source entity and the target entity.

In embodiments, augmenting the initial knowledge graph includes modifying the initial knowledge to include the new relationship triple. In other embodiments, the augmenting includes building a new knowledge graph based on the initial knowledge graph and that includes the new relationship triple.

In embodiments, the partial specification of the new relationship triple further includes an indication of the target entity of the new relationship triple, and the missing at least some relationship information includes the relationship type of the relationship between the new source entity and the target entity. The applying of the one or more machine learning models and identifying the missing at least some relationship information in these situations includes applying the classification model to predict the relationship type of the relationship between the new source entity and the target entity. This completes the relationship triple, and augmenting the initial knowledge graph includes adding the new source entity to the initial knowledge graph and relating the added new source entity in the initial knowledge graph to the target entity with the predicted relationship type.

In other embodiments, the partial specification of the new relationship triple further includes the relationship type of the relationship between the new source entity and the target entity, and the missing at least some relationship information includes an indication of the target entity. The applying of the one or more machine learning models and identifying the missing at least some relationship information in these situations includes applying the relationship-specific clustering model for the relationship type, and identifying, based on the applying the relationship-specific clustering model, a nearest entity in the initial knowledge graph. This completes the relationship triple, and augmenting the initial knowledge graph includes adding the new source entity to the initial knowledge graph and relating the added new source entity in the initial knowledge graph to the identified nearest entity, as the target entity, with the relationship type.

In yet other embodiments, the missing at least some relationship information includes both an indication of the target entity and the relationship type of the relationship between the new source entity and the target entity. The applying of the one or more machine learning models and identifying the missing at least some relationship information in these situations includes (i) applying the overall clustering model to determine an existing source entity, of the initial knowledge graph, that is most similar to the new source entity, the existing source entity being a source entity of one or more existing relationships reflected in the initial knowledge graph, (ii) applying, for each relationship type of the one or more existing relationships, the respective relationship-specific clustering model of the at least one relationship-specific clustering model, to determine a strength of each existing relationship of the one or more existing relationships, and (iii) identifying, based on the strength of each existing relationship of the one or more existing relationships, a strongest existing relationship of the one or more existing relationships, where the strongest existing relationship is between the existing source entity and an existing target entity, and has an identified relationship type. The augmenting the initial knowledge graph can include adding the new source entity to the initial knowledge graph and relating the added new source entity in the initial knowledge graph to the existing target entity with a relationship of the identified relationship type.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
obtaining an initial knowledge graph comprising nodes representing a plurality of entities and edges representing relationships between related entities of the plurality of entities;
building a dataset based on the initial knowledge graph, the dataset indicating, for each related entity pair, of a collection of related entity pairs, between which a relationship exists as represented in the initial knowledge graph:
at least one attribute and at least one attribute value of a first entity of the related entity pair;
at least one attribute and at least one attribute value of a second entity of the related entity pair;
a relationship type of the relationship between the related entity pair; and
a weight of the relationship type;
using the dataset to build a collection of machine learning models for identifying missing relationship information, the collection of machine learning models comprising at least one clustering model and at least one classification model;
receiving a partial specification of a new relationship triple to include in the initial knowledge graph, the new relationship triple comprising a new source entity, a target entity, and a relationship type of a relationship between the new source entity and the target entity, wherein the partial specification of the new relationship triple comprises a specification of the new source entity and is missing at least some relationship information of the new relationship triple;
applying one or more machine learning models of the collection of machine learning models and identifying the missing at least some relationship information of the new relationship triple to provide a complete specification of the new relationship triple; and
augmenting the initial knowledge graph using the complete specification of the new relationship triple, the augmenting providing an augmented knowledge graph that includes the new relationship triple, including the new source entity, the target entity, and the relationship type of the relationship between the new source entity and the target entity.

2. The method of claim 1, wherein, for a related entity pair of the collection of related entity pairs, a relationship, in one direction, of the first entity to the second entity is a first relationship of a first relationship type and a relationship, in another direction, of the second entity to the first entity is a second relationship of a second relationship type, and wherein the building the dataset comprises indicating in the dataset (i) the first relationship type, (ii) a weight of the first relationship type, (iii) the second relationship type, and (iv) a weight of the second relationship type.

3. The method of claim 1, wherein the dataset comprises rows and columns, wherein each row represents a relationship for a related entity pair of the collection of related entity pairs, and wherein the building the dataset defines the columns as being one selected from the group consisting of:
attributes of the plurality of entities, based on the attributes of the plurality of entities matching across the plurality of entities; and
defined categories of attributes that differ but are related, based on the attributes of the plurality of entities differing across the plurality of entities.

4. The method of claim 1, further comprising determining the weight of the relationship type based on:
a relationship strength factor that is predefined for the relationship type; and
a path length factor of the related entity pair, the path length factor being a function of:
a shortest pathlength, in the initial knowledge graph, between the first entity and the second entity; and
a longest pathlength of a set of pathlengths of the initial knowledge graph, the set of pathlengths consisting of, for each pair of entities of the plurality of entities, a respective shortest pathlength between that pair of entities.

5. The method of claim 1, wherein the collection of machine learning models comprises:
an overall clustering model that indicates, for an input source entity, an existing source entity of the initial knowledge graph that is most similar to the input source entity;
at least one relationship-specific clustering model, the at least one relationship-specific clustering model comprising, for each relationship type indicated by the dataset, a respective relationship-specific clustering model that clusters the plurality of entities based on that relationship type; and
a classification model that predicts a relationship type of a relationship between an input source entity and an input target entity based on attributes of the input source entity and the input target entity.

6. The method of claim 5, wherein the partial specification of the new relationship triple further comprises an indication of the target entity of the new relationship triple, wherein the missing at least some relationship information comprises the relationship type of the relationship between the new source entity and the target entity, wherein the applying the one or more machine learning models and identifying the missing at least some relationship information comprises applying the classification model to predict the relationship type of the relationship between the new source entity and the target entity, and wherein the augmenting the initial knowledge graph comprises adding the new source entity to the initial knowledge graph and relating the added new source entity in the initial knowledge graph to the target entity with the predicted relationship type.

7. The method of claim 5, wherein the partial specification of the new relationship triple further comprises the relationship type of the relationship between the new source entity and the target entity, wherein the missing at least some relationship information comprises an indication of the target entity, wherein the applying the one or more machine learning models and identifying the missing at least some relationship information comprises applying the relationship-specific clustering model for the relationship type, and identifying, based on the applying the relationship-specific clustering model, a nearest entity in the initial knowledge graph, and wherein the augmenting the initial knowledge graph comprises adding the new source entity to the initial knowledge graph and relating the added new source entity in the initial knowledge graph to the identified nearest entity, as the target entity, with the relationship type.

8. The method of claim 5, wherein the missing at least some relationship information comprises an indication of the target entity and the relationship type of the relationship between the new source entity and the target entity, wherein the applying the one or more machine learning models and identifying the missing at least some relationship information comprises:
applying the overall clustering model to determine an existing source entity, of the initial knowledge graph, that is most similar to the new source entity, the existing source entity being a source entity of one or more existing relationships reflected in the initial knowledge graph;
applying, for each relationship type of the one or more existing relationships, the respective relationship-specific clustering model of the at least one relationship-specific clustering model, to determine a strength of each existing relationship of the one or more existing relationships; and
identifying, based on the strength of each existing relationship of the one or more existing relationships, a strongest existing relationship of the one or more existing relationships, wherein the strongest existing relationship is between the existing source entity and an existing target entity, and has an identified relationship type;
wherein the augmenting the initial knowledge graph comprises adding the new source entity to the initial knowledge graph and relating the added new source entity in the initial knowledge graph to the existing target entity with a relationship of the identified relationship type.

9. The method of claim 5, wherein building the overall clustering model and the at least one relationship-specific clustering model comprises:
selecting which attributes to use in building the overall clustering model and the at least one relationship-specific clustering model, the selecting comprising:
building a regression model that uses weights of relationship types indicated in the dataset as targets and attributes indicated in the dataset as predictors;
determining prediction intervals value for the regression model; and
selecting, as the attributes to use, those attributes for which the corresponding prediction interval is above a selected threshold; and
based on the selected attributes to use, using those selected attributes from source entities and target entities indicated in the dataset in building the overall clustering model and the at least one relationship-specific clustering model.

10. The method of claim 1, wherein the augmenting the initial knowledge graph comprises one selected from the group consisting of: modifying the initial knowledge to include the new relationship triple, and building a new knowledge graph based on the initial knowledge graph and that includes the new relationship triple.

11. A computer system comprising:
a memory; and
a processor in communication with the memory, wherein the computer system is configured to perform a method comprising:
obtaining an initial knowledge graph comprising nodes representing a plurality of entities and edges representing relationships between related entities of the plurality of entities;
building a dataset based on the initial knowledge graph, the dataset indicating, for each related entity pair, of a collection of related entity pairs, between which a relationship exists as represented in the initial knowledge graph:
at least one attribute and at least one attribute value of a first entity of the related entity pair;
at least one attribute and at least one attribute value of a second entity of the related entity pair;
a relationship type of the relationship between the related entity pair; and
a weight of the relationship type;
using the dataset to build a collection of machine learning models for identifying missing relationship information, the collection of machine learning models comprising at least one clustering model and at least one classification model;
receiving a partial specification of a new relationship triple to include in the initial knowledge graph, the new relationship triple comprising a new source entity, a target entity, and a relationship type of a relationship between the new source entity and the target entity, wherein the partial specification of the new relationship triple comprises a specification of the new source entity and is missing at least some relationship information of the new relationship triple;
applying one or more machine learning models of the collection of machine learning models and identifying the missing at least some relationship information of the new relationship triple to provide a complete specification of the new relationship triple; and
augmenting the initial knowledge graph using the complete specification of the new relationship triple, the augmenting providing an augmented knowledge graph that includes the new relationship triple, including the new source entity, the target entity, and the relationship type of the relationship between the new source entity and the target entity.

12. The computer system of claim 11, wherein the collection of machine learning models comprises:
an overall clustering model that indicates, for an input source entity, an existing source entity of the initial knowledge graph that is most similar to the input source entity;
at least one relationship-specific clustering model, the at least one relationship-specific clustering model comprising, for each relationship type indicated by the dataset, a respective relationship-specific clustering model that clusters the plurality of entities based on that relationship type; and
a classification model that predicts a relationship type of a relationship between an input source entity and an input target entity based on attributes of the input source entity and the input target entity.

13. The computer system of claim 12, wherein the partial specification of the new relationship triple further comprises an indication of the target entity of the new relationship triple, wherein the missing at least some relationship information comprises the relationship type of the relationship between the new source entity and the target entity, wherein the applying the one or more machine learning models and identifying the missing at least some relationship information comprises applying the classification model to predict the relationship type of the relationship between the new source entity and the target entity, and wherein the augmenting the initial knowledge graph comprises adding the new source entity to the initial knowledge graph and relating the added new source entity in the initial knowledge graph to the target entity with the predicted relationship type.

14. The computer system of claim 12, wherein the partial specification of the new relationship triple further comprises the relationship type of the relationship between the new source entity and the target entity, wherein the missing at least some relationship information comprises an indication of the target entity, wherein the applying the one or more machine learning models and identifying the missing at least some relationship information comprises applying the relationship-specific clustering model for the relationship type, and identifying, based on the applying the relationship-specific clustering model, a nearest entity in the initial knowledge graph, and wherein the augmenting the initial knowledge graph comprises adding the new source entity to the initial knowledge graph and relating the added new source entity in the initial knowledge graph to the identified nearest entity, as the target entity, with the relationship type.

15. The computer system of claim 12, wherein the missing at least some relationship information comprises an indication of the target entity and the relationship type of the relationship between the new source entity and the target entity, wherein the applying the one or more machine learning models and identifying the missing at least some relationship information comprises:
applying the overall clustering model to determine an existing source entity, of the initial knowledge graph, that is most similar to the new source entity, the existing source entity being a source entity of one or more existing relationships reflected in the initial knowledge graph;
applying, for each relationship type of the one or more existing relationships, the respective relationship-specific clustering model of the at least one relationship-specific clustering model, to determine a strength of each existing relationship of the one or more existing relationships; and
identifying, based on the strength of each existing relationship of the one or more existing relationships, a strongest existing relationship of the one or more existing relationships, wherein the strongest existing relationship is between the existing source entity and an existing target entity, and has an identified relationship type;
wherein the augmenting the initial knowledge graph comprises adding the new source entity to the initial knowledge graph and relating the added new source entity in the initial knowledge graph to the existing target entity with a relationship of the identified relationship type.

16. A computer program product comprising:
a computer readable storage medium readable by a processing circuit and storing instructions for execution by the processing circuit to:
obtaining an initial knowledge graph comprising nodes representing a plurality of entities and edges representing relationships between related entities of the plurality of entities;
building a dataset based on the initial knowledge graph, the dataset indicating, for each related entity pair, of a collection of related entity pairs, between which a relationship exists as represented in the initial knowledge graph:
at least one attribute and at least one attribute value of a first entity of the related entity pair;
at least one attribute and at least one attribute value of a second entity of the related entity pair;
a relationship type of the relationship between the related entity pair; and
a weight of the relationship type;
using the dataset to build a collection of machine learning models for identifying missing relationship information, the collection of machine learning models comprising at least one clustering model and at least one classification model;
receiving a partial specification of a new relationship triple to include in the initial knowledge graph, the new relationship triple comprising a new source entity, a target entity, and a relationship type of a relationship between the new source entity and the target entity, wherein the partial specification of the new relationship triple comprises a specification of the new source entity and is missing at least some relationship information of the new relationship triple;
applying one or more machine learning models of the collection of machine learning models and identifying the missing at least some relationship information of the new relationship triple to provide a complete specification of the new relationship triple; and
augmenting the initial knowledge graph using the complete specification of the new relationship triple, the augmenting providing an augmented knowledge graph that includes the new relationship triple, including the new source entity, the target entity, and the relationship type of the relationship between the new source entity and the target entity.

17. The computer program product of claim 16, wherein the collection of machine learning models comprises:
an overall clustering model that indicates, for an input source entity, an existing source entity of the initial knowledge graph that is most similar to the input source entity;
at least one relationship-specific clustering model, the at least one relationship-specific clustering model comprising, for each relationship type indicated by the dataset, a respective relationship-specific clustering model that clusters the plurality of entities based on that relationship type; and
a classification model that predicts a relationship type of a relationship between an input source entity and an input target entity based on attributes of the input source entity and the input target entity.

18. The computer program product of claim 17, wherein the partial specification of the new relationship triple further comprises an indication of the target entity of the new relationship triple, wherein the missing at least some relationship information comprises the relationship type of the relationship between the new source entity and the target entity, wherein the applying the one or more machine learning models and identifying the missing at least some relationship information comprises applying the classification model to predict the relationship type of the relationship between the new source entity and the target entity, and wherein the augmenting the initial knowledge graph comprises adding the new source entity to the initial knowledge graph and relating the added new source entity in the initial knowledge graph to the target entity with the predicted relationship type.

19. The computer program product of claim 17, wherein the partial specification of the new relationship triple further comprises the relationship type of the relationship between the new source entity and the target entity, wherein the missing at least some relationship information comprises an indication of the target entity, wherein the applying the one or more machine learning models and identifying the missing at least some relationship information comprises applying the relationship-specific clustering model for the relationship type, and identifying, based on the applying the relationship-specific clustering model, a nearest entity in the initial knowledge graph, and wherein the augmenting the initial knowledge graph comprises adding the new source entity to the initial knowledge graph and relating the added new source entity in the initial knowledge graph to the identified nearest entity, as the target entity, with the relationship type.

20. The computer program product of claim 17, wherein the missing at least some relationship information comprises an indication of the target entity and the relationship type of the relationship between the new source entity and the target entity, wherein the applying the one or more machine learning models and identifying the missing at least some relationship information comprises:
applying the overall clustering model to determine an existing source entity, of the initial knowledge graph, that is most similar to the new source entity, the existing source entity being a source entity of one or more existing relationships reflected in the initial knowledge graph;
applying, for each relationship type of the one or more existing relationships, the respective relationship-specific clustering model of the at least one relationship-specific clustering model, to determine a strength of each existing relationship of the one or more existing relationships; and
identifying, based on the strength of each existing relationship of the one or more existing relationships, a strongest existing relationship of the one or more existing relationships, wherein the strongest existing relationship is between the existing source entity and an existing target entity, and has an identified relationship type;
wherein the augmenting the initial knowledge graph comprises adding the new source entity to the initial knowledge graph and relating the added new source entity in the initial knowledge graph to the existing target entity with a relationship of the identified relationship type.
